(19) United States
(12) Patent Application Publication
(10) Pub. No.: US 2024/0227016 A9
(43) Pub. Date: Jul. 11, 2024

(54) TILE-BASED PRINTING WITH DYNAMIC BEAM SHAPING

(71) Applicant: Divergent Technologies, Inc., Los Angeles, CA (US)

(72) Inventors: Michael Thomas KENWORTHY, Rancho Palos Verdes, CA (US); Seyedalireza Torbatisarraf, Los Angeles, CA (US)

(21) Appl. No.: 18/490,533

(22) Filed: Oct. 19, 2023

Related U.S. Application Data
(60) Provisional application No. 63/417,983, filed on Oct. 20, 2022.

(51) Int. Cl. B22F 10/36; B22F 10/28; B22F 12/90; B33Y 10/00; B33Y 30/00

(52) U.S. Cl. CPC B22F 10/36; B22F 10/28; B22F 12/90; B33Y 10/00; B33Y 30/00

(57) ABSTRACT

Aspects are provided for additively manufacturing a build piece using tile-based printing with dynamic beam shaping. An apparatus may include a powder bed depositor that deposits a layer of powder material in a powder bed, a laser beam source configured to produce a laser beam, a beam shaping component configured to adjust an energy profile of the laser beam to obtain a beam energy profile, and a controller. The controller can be configured to obtain information of the layer of powder material and control the beam shaping component to adjust a beam energy profile of the laser beam to correspond to tile energy profiles associated with a plurality of tiles in the layer. Further, the controller can be configured to apply a pulse of the laser beam to the plurality of tiles to fuse portions of the build piece corresponding to respective tiles.

### CROSS-REFERENCE TO RELATED APPLICATION

This application claims the benefit of U.S. Patent Application No. 63/417,983, entitled “TILE-BASED PRINTING WITH DYNAMIC BEAM SHAPING” and filed on Oct. 20, 2022, which is expressly incorporated by reference herein in its entirety as if set forth herein.

### BACKGROUND

### Field

The present disclosure relates generally to additive manufacturing, and more particularly, to systems and methods of dynamically shaping laser beams during additive manufacturing.

### Background

Powder-bed fusion (PBF) systems can produce structures (referred to as build pieces) with geometrically complex shapes, including some shapes that are difficult or impossible to create with conventional manufacturing processes. PBF systems include additive manufacturing (AM) techniques to create build pieces layer-by-layer. Each layer or slice can be formed by a process of depositing a layer of powder and then fusing (e.g., melting and cooling), via a laser beam, areas of the powder layer that coincide with the cross-section of the build piece in the layer. The process may be repeated to form the next slice of the build piece, and so on until the build piece is complete. Because each layer is deposited on top of the previous layer, PBF may be likened to forming a structure slice-by-slice from the ground up.

However, these AM systems lack optimized control of the laser beam across the layer such that the material in front of the processing beam melts and consolidates in an efficient manner. Further, these AM systems lack optimized, dynamic beam shaping of the laser beam to optimize various resulting properties of the build piece.

### SUMMARY

Several aspects of a variable beam geometry laser-based PBF and systems, methods, and non-transitory computer-readable mediums for additively manufacturing a build piece will be described more fully hereinafter.

In an aspect of the present disclosure, an apparatus for additively manufacturing a build piece is presented. The apparatus includes a powder bed depositor configured to deposit a layer of powder material in a powder bed. The apparatus also includes a laser beam source configured to produce a laser beam. The apparatus further includes a beam shaping component configured to adjust an energy profile of the laser beam to obtain a beam energy profile. Additionally, the apparatus includes a controller.

In one or more embodiments, the controller can be configured to obtain information of the layer of powder material, the information including a plurality of tiles of the layer and a tile energy profile associated with each of the tiles. For example, the tile energy profile can include one or more parameters. The parameters can include at least a length, a width, a depth, a power density, or a time. Further, the tile energy profile can include an energy profile based on a geometry of the build piece. The geometry of the build piece can include a geometry of an edge of the build piece. Additionally, the tile energy profile can include an energy profile that varies over time. The energy profile that varies over time can include a melting period and at least a pre-heating period or a post-heating period. Also, the tile energy profile associated with each of the tiles can include an energy profile based on at least a residual stress of the tile, a microstructure of the tile, or a speed of the pulse.

In one or more embodiments, the controller can be configured to control the beam shaping component to adjust the beam energy profile to correspond to a tile energy profile of a first tile of the plurality of tiles to obtain a first beam energy profile. In one or more embodiments, the controller can be configured to apply a pulse of the laser beam with the first beam energy profile to the first tile to fuse a portion of the build piece corresponding to the first tile. In one or more embodiments, the controller can be configured to control the beam shaping component to adjust the beam energy profile to correspond to a tile energy profile of a second tile of the plurality of tiles to obtain a second beam energy profile, in which the second beam energy profile is different than the first beam energy profile. In one or more embodiments, the first beam energy profile and the second beam energy profile have different power densities over time. In one or more embodiments, a portion of the first tile and a portion of the second tile overlap. In one or more embodiments, the controller can be configured to apply a pulse of the laser beam with the second beam energy profile to the second tile to fuse a portion of the build piece corresponding to the second tile.

In one or more embodiments, the apparatus can include a sensor configured to measure a temperature of the first tile after the controller applies the pulse of the laser beam to the first tile. The apparatus can also include a camera configured to capture an image of the first tile after the controller applies the pulse of the laser beam to the first tile. The images captured by the camera can be used to observe how particular tiles or the layer of powder material generally has shifted from pre-fusing to the current status of the build piece fusing. In other words, the camera images can provide information on what parts of the layer of powder material have cooled, shifted, or otherwise moved positionally. The apparatus can further include a steering system having the laser beam source.

In another aspect of the present disclosure, a method of additively manufacturing a build piece is presented. The method includes depositing a layer of powder material in a powder bed. The method further includes obtaining information of the layer of powder material, the information including a plurality of tiles of the layer and a tile energy profile associated with each of the tiles. In one or more embodiments, the tile energy profile includes one or more parameters. For example, the parameters can include one or more of at least a length, a width, a depth, a power density, or a time. In one or more embodiments, the tile energy profile associated with each of the plurality of tiles includes an energy profile based on a geometry of the build piece.

The method also includes controlling a beam shaping component to adjust a beam energy profile associated with a laser beam to correspond to a tile energy profile of a first tile of the plurality of tiles to obtain a first beam energy profile. Additionally, the method includes applying a pulse of the laser beam with the first beam energy profile to the first tile to fuse a portion of the build piece corresponding to the first tile. The method can include controlling the beam shaping component to adjust a beam energy profile associated with the laser beam to correspond to a tile energy profile of a second tile of the plurality of tiles to obtain a second beam energy profile, in which the second beam energy profile is different than the first beam energy profile. In one or more embodiments, the first beam energy profile and the second beam energy profile have different power densities over time. In one or more embodiments, a portion of the first tile and a portion of the second tile overlap. Moreover, the method can include applying the pulse of the laser beam with the second beam energy profile to the second tile to fuse a portion of the build piece corresponding to the second tile.

In one or more embodiments, the method further includes determining a processing order of each of the plurality of tiles. In one or more embodiments, the method also includes determining a shape of the laser beam to be applied to each of the plurality of tiles. In one or more embodiments, the method can include determining a size of each of the plurality of tiles. In one or more embodiments, the method additionally includes determining a beam speed of the laser beam to be applied to each of the plurality of tiles.

In another aspect of the present disclosure, non-transitory computer-readable mediums storing computer-executable instructions for additively manufacturing a build piece executable by a processor to carry out the methods disclosed herein are further provided.

Other aspects will become readily apparent to those skilled in the art from the following detailed description, wherein is shown and described only several exemplary embodiments by way of illustration. As will be realized by those skilled in the art, concepts described herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of the concepts described herein will now be presented in the detailed description by way of example, and not by way of limitation, in the accompanying drawings, wherein:

FIGS. 1A-1D illustrate respective side views of an exemplary L-PBF system during different stages of operation.

FIGS. 2A-2C are diagrams illustrating an exemplary powder bed having a layer of powder material subdivided into a plurality of tiles.

FIG. 2D illustrates exemplary graphs of laser beam penetration as a function of tile location and power density.

FIG. 3 is a flowchart of an exemplary method of additively manufacturing a build piece in a L-PBF apparatus.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

While this disclosure is generally directed to laser-based PBF (L-PBF) systems, it will be appreciated that such L-PBF systems may encompass a wide variety of AM techniques. Thus, the L-PBF process may include, among others, the following printing techniques: Direct metal laser sintering (DMLS), Selective laser melting (SLM) and Selective laser sintering (SLS). Still other PBF processes to which the principles of this disclosure are pertinent include those that are currently contemplated or under commercial development. While the specific details of each such process are omitted to avoid unduly obscuring key concepts of the disclosure, it will be appreciated that the claims are intended to encompass such techniques and related structures.

L-PBF systems can produce metal and polymer structures (referred to as build pieces) with geometrically complex shapes, including some shapes that are difficult or impossible to create using conventional manufacturing processes. L-PBF systems create build pieces layer-by-layer, i.e., slice-by-slice. Each slice may be formed by a process of depositing a layer of powder and fusing (e.g., melting and cooling) areas of the powder layer that coincide with the cross-section of the build piece in the slice. The process may be repeated to form the next slice of the build piece, and so on, until all the layers are deposited and the build piece is complete.

In conventional L-PBF systems, the path a laser takes across the top layer of powder (i.e., the scan pattern) is typically in patterns of parallel lines drawn back and forth across the current build layer. The orientation of the lines can vary in patches or be uniform for an entire layer. The L-PBF system then moves to the next layer and continues directing the laser beam in a pattern of stripes. For each layer, conventional L-PBF systems apply a constant energy profile.

Aspects of the present disclosure are directed to advantageous laser beam scan apparatuses, methods, and non-transitory computer readable mediums for L-PBF systems in which the build layer (e.g., a layer slice) is subdivided into identified areas (i.e., tiles), and then a customized energy profile of the laser beam is applied to each individual tile in the build layer. In one or more embodiments, the tiles are two-dimensional areas of the layer of powder. In one or more embodiments, the tiles are three-dimensional voxels of the layer of powder. The energy flux applied to each tile depends on one or more variables of the laser beam including the location of the application of the beam in two- or three-dimensions, the power of the beam, and the duration that the beam is activated and focused at a given tile. Thereafter, the L-PBF systems disclosed herein scan additional tiles and apply customized energy profiles to those respective tiles in order fuse those portions of the build piece in the build layer. Further, the systems and methods disclosed adjust the energy profiles of the laser beam to take into account the properties of different tiles in order to optimize a processing order of the tiles. For example, the adjustments of the energy profiles from tile to tile can improve the properties of the resulting build piece such as improved residual stress, improved fusing speed, or a desired microstructure in the build piece.

In one or more embodiments, tiles overlap at one or more edges of adjacent tiles. For example, where adjacent tiles share a border, the area or volume of each tile would extend slightly into the area or volume of each adjacent tile in order to provide a “stitch” design in which the build layer has no areas without tile coverage. The power of the L-PBF system may be tuned to permit fine overlap between the tiles. In one or more embodiments, tiles do not overlap the edges of adjacent tiles and instead the edges of adjacent tiles abut one another.

In the L-PBF systems disclosed herein, the laser beam may be configured to use variable beam or spot geometries (i.e., beam shaping) to increase build rate and provide additional control and flexibility of the manufacturing process. A laser spot is the area of a surface illuminated by a laser. Rather than use a laser beam configured as terminating in a tiny, almost point-like spot with a small radius that remains constant over time, a laser beam may instead be configured to use variable beam or spot geometries according to the direction of the scan based on the energy profile of the tile to be fused or the build piece. For example, the beam geometry—that is, the area of the surface of the print material illuminated by the laser—may be a line, a square, a rectangle, a triangle, an asymmetrical shape, or any other two-dimensional shape. The identified beam geometry can then be applied to the surface of the print material using two- or three-dimensional scanning. In so doing, the laser beam may be applied in a PBF print operation such that a larger contiguous area of the powder-bed may be processed at any given time. In an embodiment, the beam geometry can be dynamically altered during a 3-D print operation. Thus, for example, the L-PBF 3-D printer may fuse larger areas using a correspondingly large beam geometry, and subsequently or periodically, the 3-D printer may alter the beam geometry to a small line or an ordinary point-like shape to scan corner portions of the object and/or to fuse details of the build piece on a smaller scale.

In one or more embodiments, dynamic beam shaping as disclosed herein may be performed by varying beam focal length or beam intensity via a beam shaping component in order to change the beam shape using programmable laser beam sources. The beam shaping component may include one or more fixed or motorized optical elements of any necessary or suitable physical form. The beam shaping component may also include multiple diffracting, reflecting and refracting apparatus, such as diffractive beam splitters, diffractive diffusers, phase plates, lenses and mirrors. These laser beam sources can be programmed to output pulsed-type laser beams whose beam shapes vary according to the tile to be processed.

In accordance with aspects of the present disclosure, the laser beam geometry may be adapted based on the energy profiles of the object (build piece) to be produced according to the tile energy profile associated with each of a plurality of tiles in a build layer. The laser beam geometry may be adapted at the beginning of a scan, on a slice-by slice basis, on a tile-by-tile basis, at a designated time within a slice, or dynamically on the fly. Further, the laser beam geometry may also be varied continuously as the laser scans across the powder-bed, whose variance is in accordance with the contemplated structure of the object as identified in a computer aided design (CAD) profile, for example.

Employing the variable beam shaping may beneficially increase the throughput of the L-PBF process. Additionally, adapting the beam shaping as described herein may allow for application of laser power over a larger area to the powder bed, meaning that energy flux can be kept small to reduce vaporization of materials. Furthermore, given the nature of the adapted laser spot geometry, the energy profile of the spot geometry may be adjusted according to the scan vector (direction of scanning), to provide heating and cooling rate control. Controlling the cooling rate during the solidification process may allow reduction of thermal stresses and alterations of microstructure in the resultant component to achieve desired material properties. Further, the addition of three-dimensional energy flux in a particular powder layer also improves residual stress and the microstructure of the build piece.

In one or more embodiments, the process order of tiles that are fused can be optimized for various variables such as residual stress, build time speed, or material distribution on the build layer. For example, to manage residual stress in a tile, the laser beam can be pulsed according to different parameters to heat portions of the tile at different lengths, widths, or depths. The heating may occur below, at, or above the melting point of the powder in order to build portions of the build piece in respective tiles at that layer and stitch those portions to portions in adjacent layers (i.e., in the Z-axis) to manage residual stress during laser beam exposure. Further, the process order the of tiles can take into account the properties of adjacent tiles, including temperature, status of the build piece structure in those tiles, and the like. In one or more embodiments, the process order of the tiles is dynamically determined in substantially real-time.

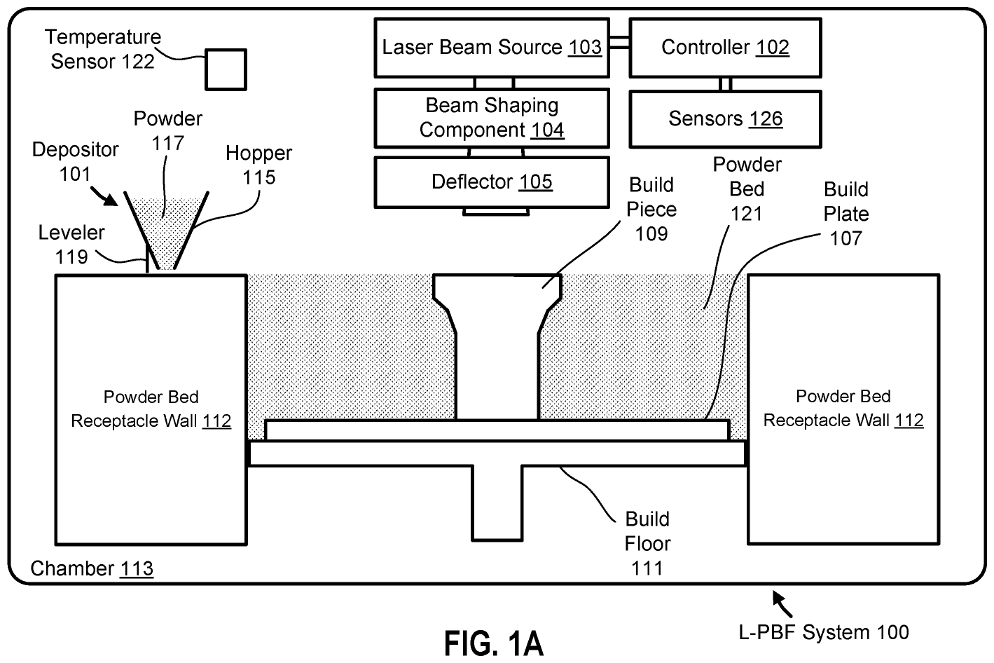

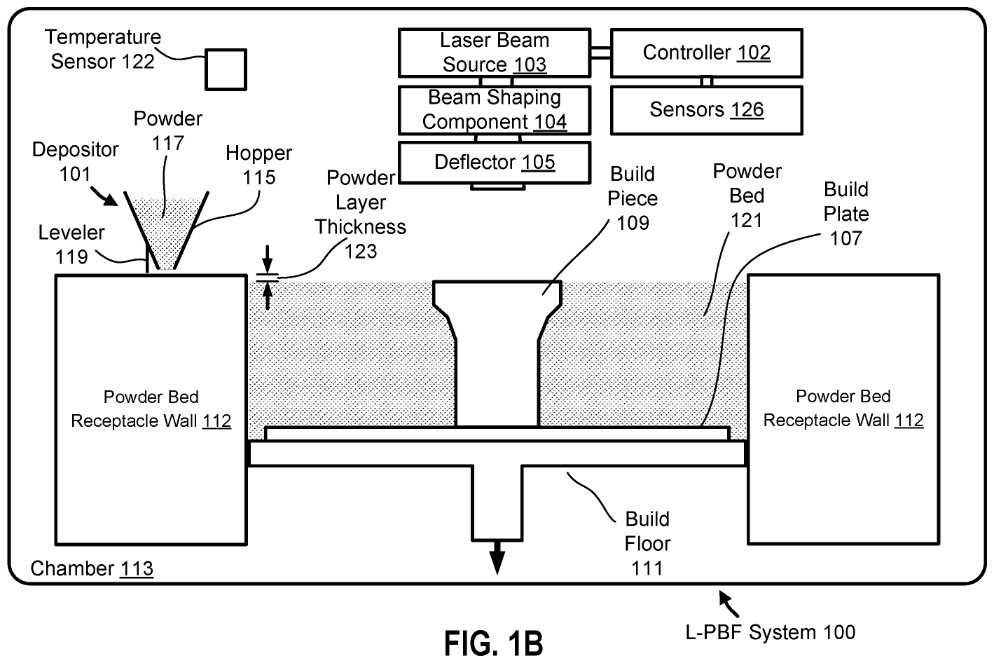

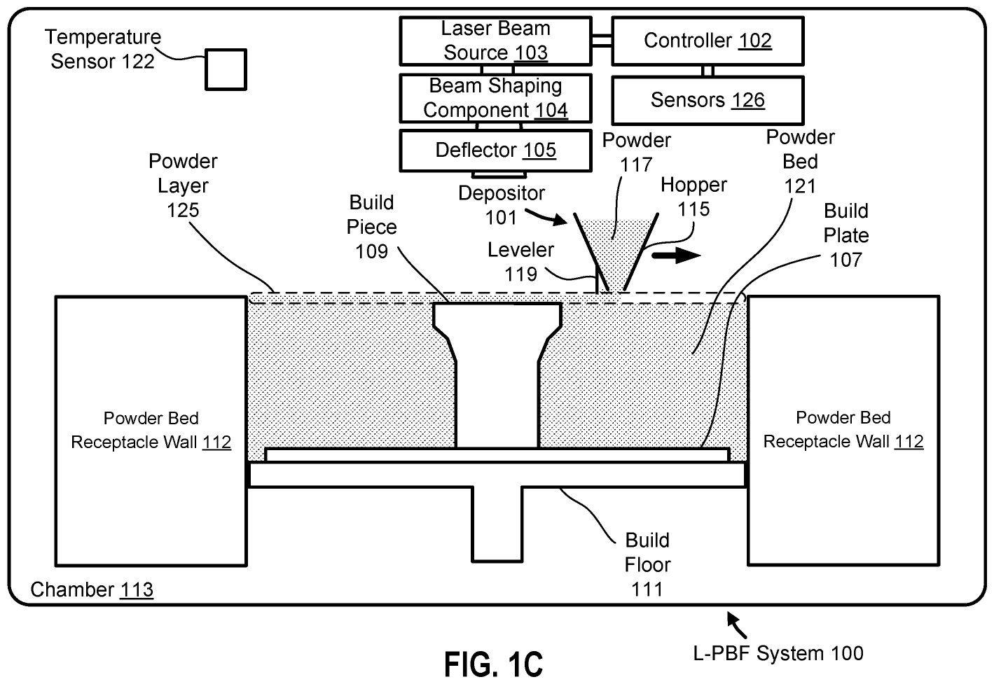

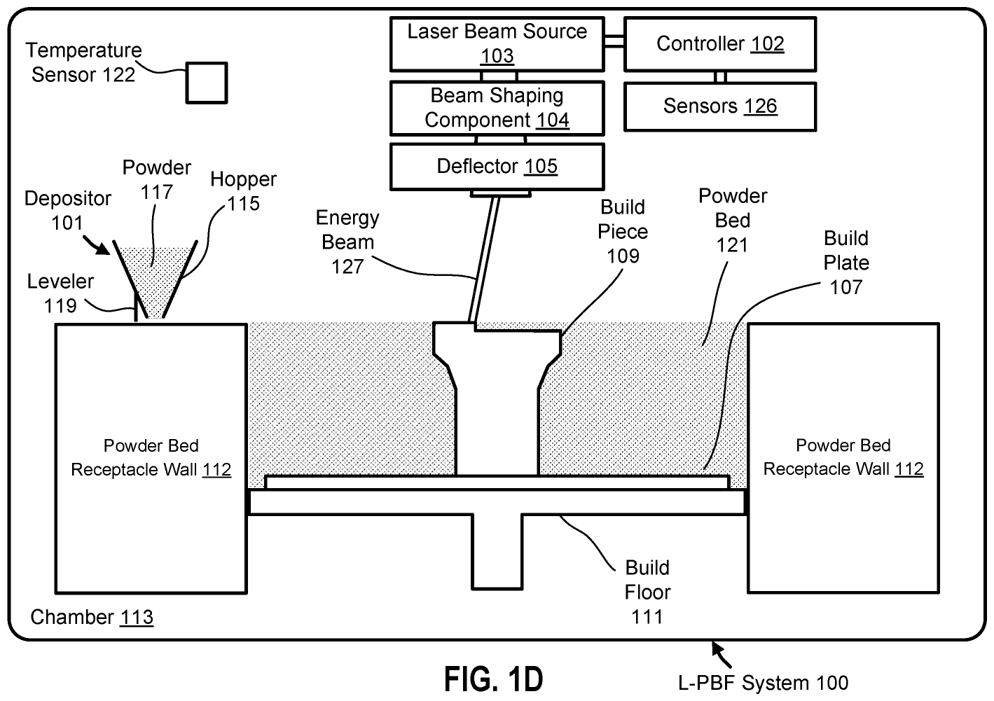

FIGS. 1A-D illustrate respective side views of an exemplary laser-based PBF (L-PBF) system 100 during different stages of operation. As noted above, the particular embodiment illustrated in FIGS. 1A-D is one of many suitable examples of a L-PBF system employing principles of this disclosure. It should also be noted that elements of FIGS. 1A-D and the other figures in this disclosure are not necessarily drawn to scale but may be drawn larger or smaller for the purpose of better illustration of concepts described herein. L-PBF system 100 may include a depositor 101 that may deposit each layer of powder material, a controller 102, a laser beam source 103 that may generate a laser beam, a beam shaping component 104 that may shape the laser beam according to a selected beam geometry, a deflector 105 that may apply the laser beam in the form of the selected beam geometry to fuse the powder material, and a build plate 107 that may support one or more build pieces, such as a build piece 109.

The controller 102 or other processing system may coordinate the L-PBF additive manufacturing process. The controller 102 can be a central processing unit or other type of processor as is known. In one or more embodiments, the controller 102 may be operatively coupled to the positioning systems controlling the L-PBF system 100 based structures (e.g., depositor 101, laser beam source 103, beam shaping component 104, etc.). In this way, an organized timing of operations can be carefully coordinated by a central controller.

While the laser beam source 103 and the beam shaping component 104 have been generally identified as separate components, in some exemplary embodiments the functionality of both components may be included as part of a single integrated structure without departing from the scope of the disclosure.

In one or more embodiments the laser beam source 103 is contained within or coupled to a steering system or a Gantry system.

The L-PBF system 100 may also include a build floor 111 positioned within a powder bed receptacle. The walls of the powder bed receptacle 112 may generally define the boundaries of the powder bed receptacle, which is defined between the walls 112 from the side and a portion of the build floor 111 below. The build floor 111 may progressively lower build plate 107 such that depositor 101 may deposit a next layer of powder material. The L-PBF system 100 may additionally include a chamber 113 that may enclose the other components of L-PBF system 100 (e.g., controller 102, laser beam source 103, beam shaping component 104 and deflector 105), thereby protecting such other components, enabling atmospheric and temperature regulation and mitigating contamination risks. Further, the L-PBF system 100 may include a temperature sensor 122 to monitor the atmospheric temperature, the temperature of the powder 117 and/or components of the L-PBF system 100. Depositor 101 may include a hopper 115 that contains a powder 117, such as a metal powder, for example. The depositor 101 may also include a leveler 119 that may level the top of each layer of deposited powder (see e.g., powder layer 125 of FIG. 1C) by displacing deposited powder 117 above a predefined layer height (e.g., corresponding to powder layer thickness 123 of FIG. 1B).

Referring specifically to FIG. 1A, this figure shows L-PBF system 100 after a slice of build piece 109 has been fused, but before the next layer of powder 117 has been deposited. In fact, FIG. 1A illustrates a time at which L-PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows L-PBF system 100 at a stage in which build floor 111 may lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows L-PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness of substantially equal to the powder layer thickness 123 (see FIG. 1B). Thus, the powder 117 in L-PBF system 100 may be supported by a powder material support structure, which may include, for example, a build plate 107, a build floor 111, a build piece 109, walls 112, and the like. It should be noted that the illustrated thickness of powder layer 125 (e.g., powder layer thickness 123 of FIG. 1B) may be greater than an actual thickness used for the example involving 150 previously deposited layers discussed above with reference to FIG. 1A.

In one or more embodiments, information about the powder layer 125 can be obtained by one or more sensors 126 of the L-PBF system 100. Sensors 126 may capture information about powder layer 125 and other conditions within the chamber 113. For example, sensors 126 can collect information regarding the amount of powder in portions of the powder layer, the temperature of the layer at different portions of the powder layer, and other (including depth), or other characteristics of the layer. In one or more embodiments, sensors 126 are operatively coupled to controller 102 such that information collected by the sensors can be processed by the controller. In one or more embodiments, the controller 102 can receive information dividing the layer of powder material into a plurality of tiles or areas of the layer. In one or more embodiments, a tile energy profile is associated with each of the tiles. The tiles can form a grid, can overlap adjacent tiles, or be other shapes and sizes as necessary for the build piece.

In automated embodiments where temperature is closely monitored (e.g., using temperature sensors adjacent to the build piece), the order of tiles for printing may occur on the fly. That is, the controller may determine the order after printing has begun, based on the temperature of the deposited layers, the intended geometry of the finished build piece, or other factors.

FIG. 1D illustrates the L-PBF system 100 generating a next slice in build piece 109 following the deposition of powder layer 125 (FIG. 1C). Referring to FIG. 1D, the laser beam source 103 may generate a laser beam. The beam shaping component 104 may be used to vary the geometric shape of the laser beam to be in the form of a line, a square, a rectangle, or other two-dimensional shape. In some aspects, the beam shaping component 104 may shape the laser beam through phase plates and free spacing propagation. The beam shaping component 104 may include multiple diffracting, reflecting and refracting apparatus, such as diffractive beam splitters, diffractive diffusers, phase plates, lenses, mirrors or other optical elements. Changes in the size and geometry of the laser beam 127 may, for example, be achieved by motorized displacement of the optical elements of beam shaping component 104. In one or more embodiments, the controller 102 can execute instructions to be configured to control the beam shaping component 104 to adjust a beam energy profile associated with the laser beam source 103 to correspond to a tile energy profile of a first tile of the plurality of tiles in the powder layer 125 to obtain a first beam energy profile. In some aspects, the geometry of the beam shape may be set according to the build piece 109. The geometry of the beam shape may be modified on a tile-by-tile or slice-by slice basis based on the geometry of the build piece to reduce scan time, achieve residual stress or particular microstructure of the build piece for a particular tile, slice, or layer. In some aspects, the geometry of the beam shape may also be modified mid-tile, mid-layer, or even continuously throughout the scanning of the build piece 109.

Thereafter, the controller 102 can be configured to apply a pulse of the laser beam with the first beam energy profile to the first tile to fuse a portion of the build piece corresponding to the first tile. Deflector 105 may apply the laser beam 127 in the selected geometric shape to fuse the identified first tile in build piece 109. In various embodiments, the deflector 105 may include one or more gimbals and actuators that can rotate and/or translate the laser beam source 103 and/or beam shaping component 104 to position the laser beam 127. In various embodiments, laser beam source 103, beam shaping component 104 and/or deflector 105 can modulate the laser beam, e.g., turn the laser beam on and off as the deflector scans such that the laser beam is applied only in the appropriate areas of the powder layer. For example, in various embodiments, the laser beam can be modulated by a digital signal processor (DSP).

In some aspects, the controller 102 can be configured to control the beam shaping component 104 to adjust the beam energy profile to correspond to a tile energy profile of a second tile of the plurality of tiles to obtain a second beam energy profile. For example, the second beam energy profile is different than the first beam energy profile. Thereafter, the controller 102 can be configured to apply a pulse of the laser beam source 103 with the second beam energy profile to the second tile to fuse a portion of the build piece corresponding to the second tile.

In one or more embodiments, the beam energy profile can be adjusted based on a customized time profile. In other words, the controller can configure the laser beam to activate for a duration of t₀ to t₁ at an initial power, then from a duration of t₁ to t₂ at a revised power. For example, the controller can configure the laser beam to activate at a particular tile at 400 watts for a selected duration, then activate at that same tile at 600 watts for a different duration. Further, the controller can configure the system to scan the laser across the tile as the applied laser beam power is varied. In this way, the systems herein can time vary the energy input to achieve a desired microstructure in the build piece.

As shown in FIG. 1D, much of the fusing of the tiles of powder layer 125 occurs in areas of the powder layer that are on top of the previous slice, i.e., previously fused powder. An example of such an area is the surface of build piece 109. The fusing of the powder layer in FIG. 1D is occurring over the previously fused layers characterizing the substance of build piece 109.

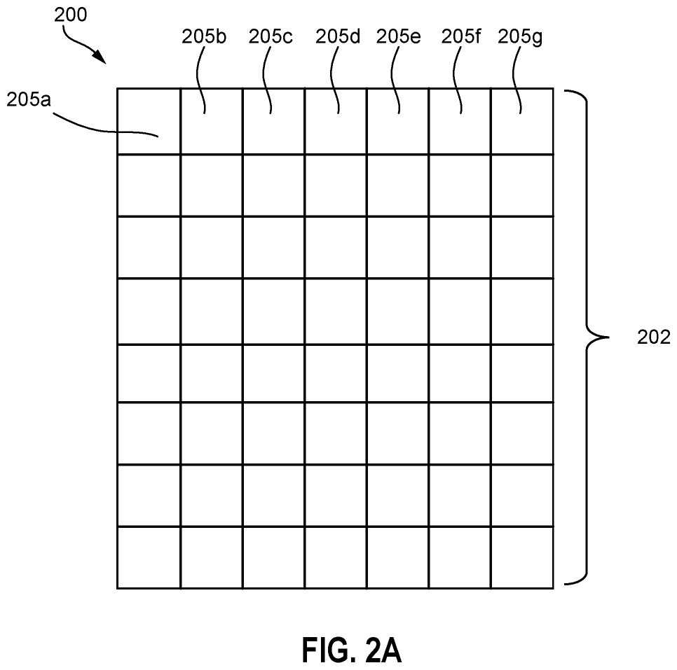

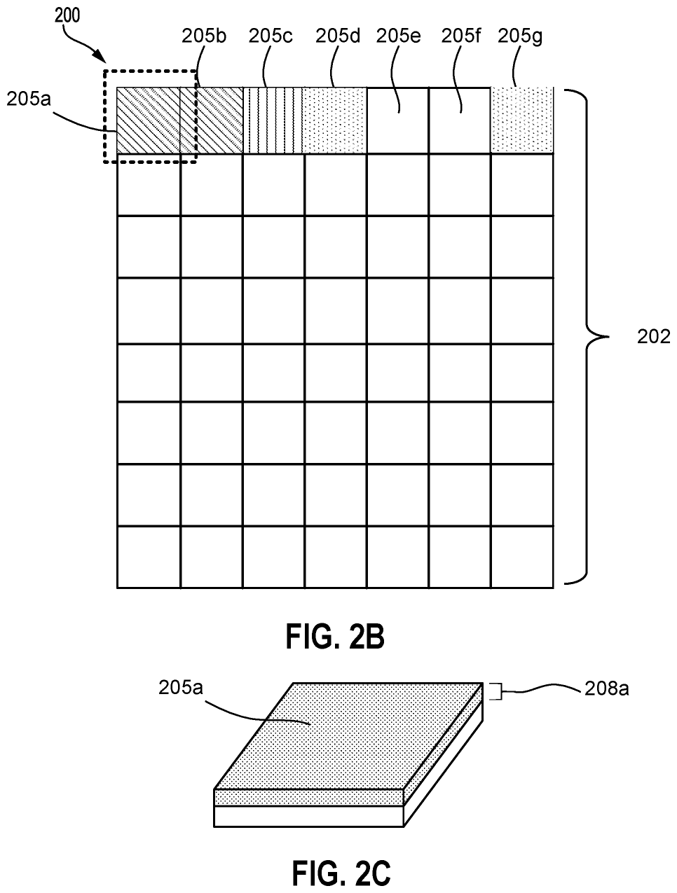

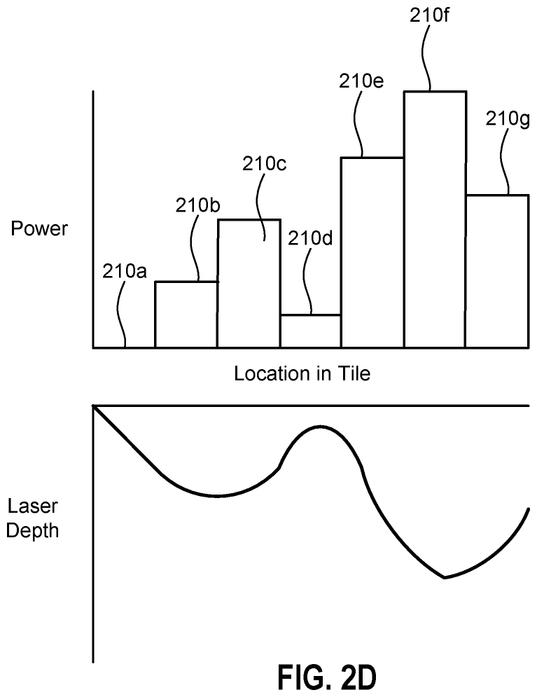

With reference now to FIGS. 2A-2C, an exemplary powder bed 200 containing a deposited layer of powder material 202 is provided. In one or more embodiments, powder bed 200 can a powder bed be as described elsewhere herein (e.g., powder bed 121). In one or more embodiments, the layer of powder material 202 can be a layer of powder material as described elsewhere herein (e.g., powder layer 125). Information about the layer of powder material 202 may be obtained by one or more sensors or cameras (not shown) operatively configured to obtain information about powder bed 200.

As illustrated by FIG. 2A, the layer of powder material 202 is subdivided into a plurality of tiles 205a, 205b, 205c, 205d, 205e, 205f, 205g, etc. While the plurality of tiles 205 are illustrated as a grid, the tiles are not required to be subdivided into a grid. For example, the plurality of tiles 205 can be square, rectangular, circular, triangular, or other geometric or non-geometric shapes. In some embodiments, the plurality of tiles 205 are equal-sized or approximately equal-sized. In other embodiments, the plurality of tiles 205 are differently sized. Furthermore, while the layer of powder material 202 is shown in FIG. 2B from a top-down perspective, the plurality of tiles 205 are not limited to a two-dimensional area. Rather, each tile 205 can be a three-dimensional voxel having a volume. For example, the depth 208a of the volume of a tile can be the depth of the that tile in a particular slice of the powder material 202 being scanned as shown by the broken-out view of tile 205a in FIG. 2C.

Each of the plurality of tiles 205 has an energy profile associated with each tile. An energy profile is a representation of the scanning to performed by the laser beam at the tile. These respective energy profiles correspond with the portion of the build piece to be fused in the respective tile area. These energy profiles can be different from tile to tile or may be the same. For example, as illustrated by FIG. 2D, tile 205a and 205b have the same energy profile, tile 205c has a different energy profile than tiles 205a, 205b, tiles 205d and 205g have a still further energy profile, and tiles 205e, 205f have no associated energy profile, which means that no fusing is to occur at those tiles.

In one or more embodiments, in shaping the laser beam, an energy profile associated with a laser beam may be configured such that the energy levels may be adjusted along the three-dimensions of a respective tile 205. This laser beam energy profile represents the power density of the laser beam as applied to the tile 205 over time. In other words, the laser beam source can be tuned to produce a laser beam that is applied as a pulse to a particular tile at a certain power, at a certain location of the tile, and tuned to penetrate to a depth that matches the energy profile of the tile. As shown in FIG. 2D, the energy profile of the beam can be varied as the laser beam moves across the tile such that the laser beam penetrates the tile 205 at different locations in the plane of the tile, as well as penetrates at different depths depending on the energy profile. The depth of the laser beam penetration may be based on the successive increase and decrease of the power applied to the tile surface (i.e., the energy flux). For example, in region 210a, the energy flux level is at zero. Thereafter, the laser beam scan continues across the tile in regions 210b, 210c with increased power and thus increased energy flux applied to the tile and increased heating penetration of the powder material. As each successive region is applied to the same area of powder material, the energy flux level (e.g., laser beam intensity) may be increased and in turn, the temperature of the powder material may be increased. Thereafter, in region 210d, the power is reduced and the reduced energy flux results in reduced penetration into the powder layer. The power is successively adjusted of the laser beam at regions 210e, 210f, 210g in order to match the energy profile associated with the tile.

In one or more embodiments, the laser beam energy profile can be configured to preheat the powder material before heating the powders to melting, thermal fluctuation. Accordingly, resultant thermal stresses may be reduced.

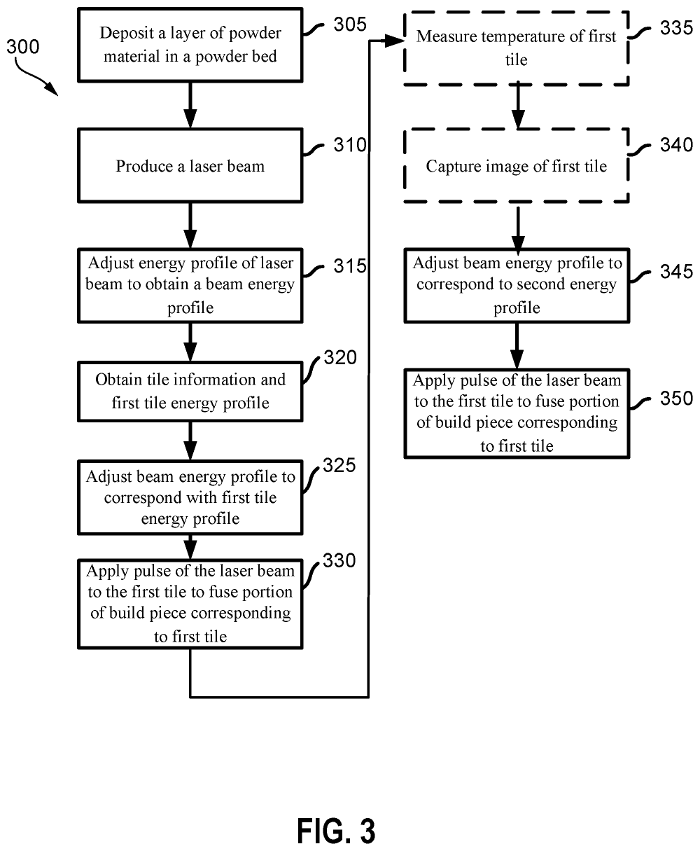

FIG. 3 is a flowchart of an exemplary method 300 of additively manufacturing a build piece in a L-PBF apparatus according to the disclosure herein. Referring first to step 305, the method 300 includes depositing a layer of powder material in a powder bed. The layer of powder material may be deposited by a depositor, for example. Further, the layer of powder may be subdivided into a plurality of tiles (i.e., portions or areas of the build layer) each having a width, length, and depth. At step 310, a laser beam source is configured to produce a laser beam. This laser beam includes an associated beam energy profile, which may be adjusted by a beam shaping component, step 315.

Thereafter, the method 300 continues by obtaining information of the layer of powder material, the information including a plurality of tiles of the layer and a tile energy profile associated with each of the tiles, step 320. In one or more embodiments, a processing order of each of the plurality of tiles is determined. For example, the processing order of the tiles may be determined by optimizing tile processing order to generate a build piece having a desired residual stress or microstructure at particular tiles. In one or more embodiments, the processing order of the plurality of tiles takes into account the energy profile of adjacent tiles.

At step 325, the method 300 controls the beam shaping component to adjust the beam energy profile to correspond to a tile energy profile of a first tile of the plurality of tiles to obtain a first beam energy profile. Thereafter, a pulse of the laser beam is applied with the first beam energy profile to the first tile to fuse a portion of the build piece corresponding to the first tile, step 330. For example, the pulse of the laser beam can be applied at the first tile by scanning the laser beam across the tile in the horizontal plane of the tile. In some embodiments, the pulse of the laser beam can be turned off after the pulse is applied for a period of time, then the laser beam spot is moved to a different location in the tile according to the first tile energy profile and the pulse of the laser beam is applied again. In one or more embodiments, the pulse of the laser beam is fixed at a beam spot at the tile. In one or more embodiments, the pulse of the laser beam can have some slight movement about the beam spot at the tile. In one or more embodiments, the application of the pulse of the laser beam is carried out in view of the shape of the tile to be fused. For example, the pulse of the laser beam may be applied to the perimeter of a circular tile before applying the laser beam to the interior of the tile.

Optionally, the method 300 continues by measure, by a sensor, a temperature of the first tile after the controller applies the pulse of the laser beam to the first tile, step 335. Based on the temperature information, the pulse of the laser beam can be adjusted to optimize fusing portions of the build piece. Optionally, at step 340, the method 300 can include capturing, by a camera, an image of the first tile after the pulse of the laser beam has been applied to the first tile. By capturing images, the progress of the build piece can be reviewed and checked for possible fusing errors.

Thereafter, at step 345, the beam shaping component can be controlled to adjust the beam energy profile to correspond to a tile energy profile of a second tile of the plurality of tiles to obtain a second beam energy profile. In one or more embodiments, the second beam energy profile is different than the first beam energy profile. At step 350, the method 300 applies a pulse of the laser beam with the second beam energy profile to the second tile to fuse a portion of the build piece corresponding to the second tile.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other support structures and systems and methods for removal of support structures. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus for additively manufacturing a build piece comprising:
a powder bed depositor configured to deposit a layer of powder material in a powder bed;
a laser beam source configured to produce a laser beam;
a beam shaping component configured to adjust an energy profile of the laser beam to obtain a beam energy profile; and
a controller configured to:
obtain information of the layer of powder material, the information including a plurality of tiles of the layer and a tile energy profile associated with each of the tiles,
control the beam shaping component to adjust the beam energy profile to correspond to a tile energy profile of a first tile of the plurality of tiles to obtain a first beam energy profile,
apply a pulse of the laser beam with the first beam energy profile to the first tile to fuse a portion of the build piece corresponding to the first tile,
control the beam shaping component to adjust the beam energy profile to correspond to a tile energy profile of a second tile of the plurality of tiles to obtain a second beam energy profile, wherein the second beam energy profile is different than the first beam energy profile, and
apply a pulse of the laser beam with the second beam energy profile to the second tile to fuse a portion of the build piece corresponding to the second tile.

2. The apparatus of claim 1, wherein the tile energy profile comprises one or more parameters.

3. The apparatus of claim 2, wherein the one or more parameters include at least a length, a width, a depth, a power density, or a time.

4. The apparatus of claim 1, wherein the first beam energy profile and the second beam energy profile have different power densities over time.

5. The apparatus of claim 1, wherein a portion of the first tile and a portion of the second tile overlap.

6. The apparatus of claim 1, further comprising a sensor configured to measure a temperature of the first tile after the controller applies the pulse of the laser beam to the first tile.

7. The apparatus of claim 1, further comprising a camera configured to capture an image of the first tile after the controller applies the pulse of the laser beam to the first tile.

8. The apparatus of claim 1, further comprising a steering system having the laser beam source.

9. The apparatus of claim 1, wherein the tile energy profile associated with each of the plurality of tiles includes an energy profile based on a geometry of the build piece.

10. The apparatus of claim 9, wherein the geometry of the build piece includes a geometry of an edge of the build piece.

11. The apparatus of claim 1, wherein the tile energy profile associated with each of the tiles includes an energy profile based on different depths of melting of the powder material in the tile.

12. The apparatus of claim 1, wherein the tile energy profile associated with each of the tiles includes an energy profile that varies over time.

13. The apparatus of claim 12, wherein the energy profile that varies over time includes a melting period and at least a pre-heating period or a post-heating period.

14. The apparatus of claim 1, wherein the tile energy profile associated with each of the tiles includes an energy profile based on at least a residual stress of the tile, a microstructure of the tile, or a speed of the pulse.

15. A method of additively manufacturing a build piece comprising:
depositing a layer of powder material in a powder bed;
obtaining information of the layer of powder material, the information including a plurality of tiles of the layer and a tile energy profile associated with each of the tiles;
controlling a beam shaping component to adjust a beam energy profile associated with a laser beam to correspond to a tile energy profile of a first tile of the plurality of tiles to obtain a first beam energy profile;
applying a pulse of the laser beam with the first beam energy profile to the first tile to fuse a portion of the build piece corresponding to the first tile;
controlling the beam shaping component to adjust a beam energy profile associated with the laser beam to correspond to a tile energy profile of a second tile of the plurality of tiles to obtain a second beam energy profile, wherein the second beam energy profile is different than the first beam energy profile; and
applying the pulse of the laser beam with the second beam energy profile to the second tile to fuse a portion of the build piece corresponding to the second tile.

16. The method of claim 15, wherein the tile energy profile comprises one or more parameters.

17. The method of claim 16, wherein the one or more parameters include one or more of at least a length, a width, a depth, a power density, or a time.

18. The method of claim 15, wherein the first beam energy profile and the second beam energy profile have different power densities over time.

19. The method of claim 15, wherein a portion of the first tile and a portion of the second tile overlap.

20. The method of claim 15, further comprising determining a processing order of each of the plurality of tiles.

21. The method of claim 15, further comprising determining a shape of the laser beam to be applied to each of the plurality of tiles.

22. The method of claim 15, wherein the tile energy profile associated with each of the plurality of tiles includes an energy profile based on a geometry of the build piece.

23. The method of claim 15, further comprising determining a size of each of the plurality of tiles.

24. The method of claim 15, further comprising determining a beam speed of the laser beam to be applied to each of the plurality of tiles.

25. A non-transitory computer-readable medium storing computer-executable instructions for additively manufacturing a build piece executable by a processor to:
deposit a layer of powder material in a powder bed;
obtain information of the layer of powder material, the information including a plurality of tiles of the layer and a tile energy profile associated with each of the tiles;
control a beam shaping component to adjust a beam energy profile associated with a laser beam to correspond to a tile energy profile of a first tile of the plurality of tiles to obtain a first beam energy profile;
apply a pulse of the laser beam with the first beam energy profile to the first tile to fuse a portion of the build piece corresponding to the first tile;
control the beam shaping component to adjust a beam energy profile associated with the laser beam to correspond to a tile energy profile of a second tile of the plurality of tiles to obtain a second beam energy profile, wherein the second beam energy profile is different than the first beam energy profile; and
apply the pulse of the laser beam with the second beam energy profile to the second tile to fuse a portion of the build piece corresponding to the second tile.
